(19) United States
(12) Patent Application Publication
(10) Pub. No.: US 2014/0185997 A1
(43) Pub. Date: Jul. 3, 2014

(54) VERTICAL-TYPE OPTICAL WAVEGUIDE AND METHOD FOR MAKING SAME

(71) Applicant: HON HAI PRECISION INDUSTRY CO., LTD., New Taipei (TW)

(72) Inventor: BING-HENG LEE, New Taipei (TW)

(73) Assignee: HON HAI PRECISION INDUSTRY CO., LTD., New Taipei (TW)

(21) Appl. No.: 13/948,241

(22) Filed: Jul. 23, 2013

(30) Foreign Application Priority Data
Dec. 28, 2012 (TW) 101151115

(51) Int. Cl. G02B 6/10

(52) U.S. Cl. CPC G02B 6/10
USPC 385/129; 427/163.2

(57) ABSTRACT

A vertical-type optical waveguide includes a substrate, a first groove, a second groove, and a protrusion portion. The first groove and the second groove are defined on a top surface of the substrate using a slicing method, and the first groove and the second groove are perpendicular to the top surface. An extending direction of the first groove and the second groove are parallel with each other. The protrusion portion is formed between the first and the second grooves. A titanium (Ti) film is coated on the protrusion portion and the Ti is diffused into the protrusion portion.

### BACKGROUND

1. Technical Field

The present disclosure relates to an optical waveguide, and particularly to a vertical-type optical waveguide and a manufacturing method of the vertical-type optical waveguide.

2. Description of Related Art

Optical waveguides are common elements used in optical elements for effective transmission of optical signals. Ridge-type optical waveguides are widely used, since the ridge-type optical waveguides have a lower optical loss as compared to planar-type optical waveguides. However, if surface flatness of top and both sides of the manufactured ridge-type optical waveguide is uneven, some optics may be scattered, and will sustain optical loss.

Therefore, there is a need to provide an optical waveguide, which can overcome the above-mentioned problems.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is a schematic view of a vertical-type optical waveguide, according to an embodiment.

FIG. 2A to 2G constitute a schematic process chart for producing a vertical-type optical waveguide, according to an embodiment, in which:

FIG. 2A shows a step of providing a substrate;

FIG. 2B shows a step of slicing a first groove and a second groove on a top surface of the substrate;

FIG. 2C shows a step of spin coating a photoresist on the top surface of the substrate;

FIG. 2D shows a step of removing the photoresist on the top of a protrusion portion;

FIG. 2E shows a step of coating a titanium (Ti) film on the top surface of the protrusion portion;

FIG. 2F shows a step of removing residual photoresist; and

FIG. 2G shows a step of forming the vertical-type optical waveguide by coating the titanium (Ti) film on the protrusion portion and then diffusing the Ti into the proportion portion by a high temperature diffusion technology.

FIG. 3 is a manufacturing process flow chart of the vertical-type optical waveguide.

### DETAILED DESCRIPTION

Embodiments will now be described in detail below with reference to the drawings.

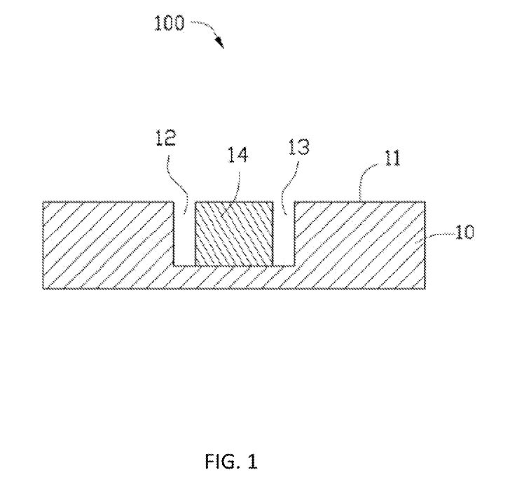

FIG. 1 shows a vertical-type optical waveguide 100 according an exemplary embodiment. The vertical-type optical waveguide 100 includes a substrate 10, a top surface 11, a first groove 12, a second groove 13, and a protrusion portion 14 formed between the first groove 12 and the second groove 13. In the embodiment, the substrate 10 is made of lithium niobate (LiNbO3) crystal, but the disclosure is not limited thereto. The first groove 12 and the second groove 13 are defined in the top surface 11 of the substrate 10 and are perpendicular to the top surface 11. The first groove 12 and the second groove 13 extend parallel to each other. The protrusion portion 14 is diffused with titanium (Ti).

Since the first groove 12 and the second groove 13 are perpendicular to the top surface 11, both sides of the protrusion portion 14 are perpendicular to the top surface 11. That is, both sides of ridge-structure are more flat, therefore the optics are not easily be scattered, increasing optical efficiency.

Depth from the top surface 11 of the substrate 10 to a bottom of the first groove 12 is the same as depth from the top surface 11 of the substrate 10 to a bottom of the second groove 13. The depth of the first groove 12 and the second groove 13 can be customized by the user. A distance between the first groove 12 and the second groove 13 can be set according to different wavelengths of light. In the present embodiment, a single mode optic is used, a wavelength of the single mode optic is less than 9 μ, therefore, the distance between the first groove 12 and the second groove 13 is 9 μm.

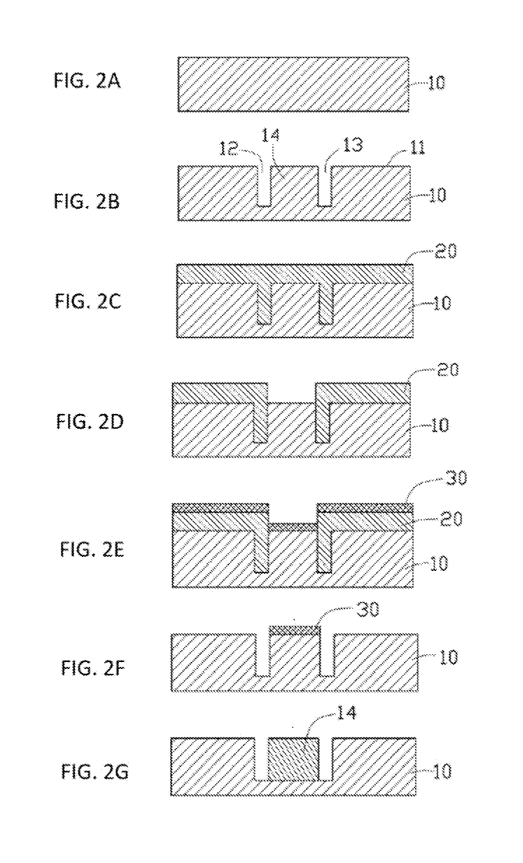

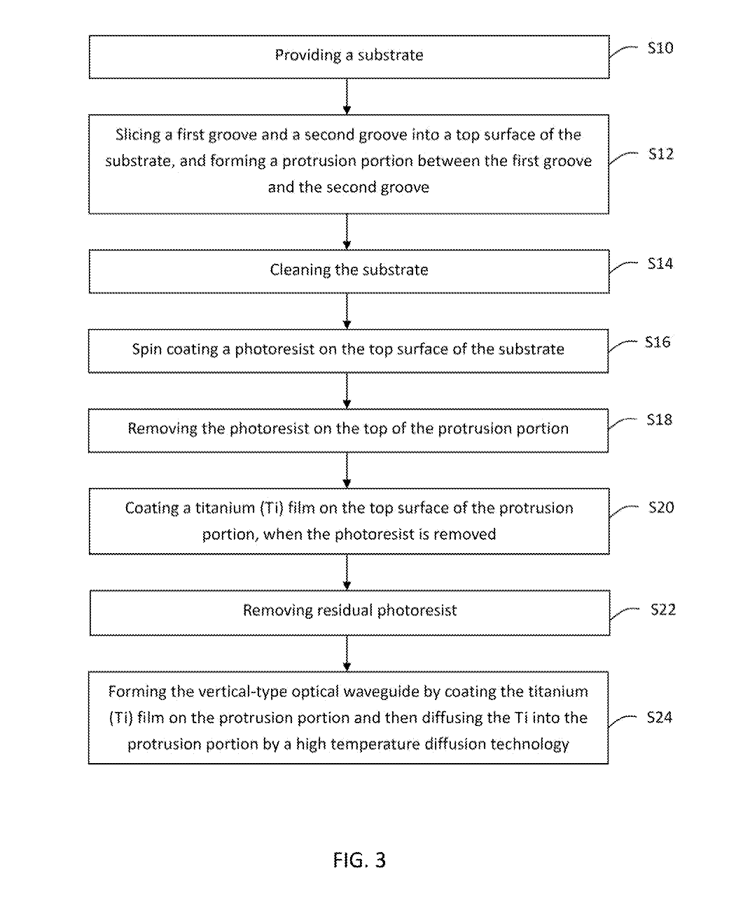

FIGS. 2A to 2G constitute a schematic process chart for producing a vertical-type optical waveguide, according to an embodiment. FIG. 3 shows that a manufacturing process flow chart of the vertical-type optical wavelength 100 of the present embodiment, includes the following steps:

In step S10: a substrate 10 is provided, as shown in FIG. 2A. Wherein the substrate 10 is substantially rectangular and is made of lithium niobate (LiNbO3) crystal, but the disclosure is not limited thereto.

In step S12: a first groove 12 and a second groove 13 are sliced into a top surface 11 of the substrate 10, as shown in FIG. 2B. The first and the second grooves 12, 13 are perpendicular to the top surface 11, then a protrusion portion 14 is formed between the first groove 12 and the second groove 13. A cutting machine employing a precision slicing wheel is used for the slicing process.

In step S14: the substrate 10 is cleaned after the slicing process.

In step S16: the top surface 11 of the substrate 10 is spin coated with a photoresist 20, as shown in FIG. 2C. A speed of spin coating is not less than 6000 rpm.

In step S18: the photoresist 20 on atop of the protrusion portion 14 is then removed, as shown in FIG. 2D. The above process is achieved using a photolithography technology.

In step S20: a titanium (Ti) film 30 is coated on the top surface of the protrusion portion 14 when the photoresist 20 is removed, as shown in FIG. 2E.

In step S22: residual photoresist 20 is removed. In this embodiment, the photoresist 20 is made of polymethyl methacrylate (PMMA), immerses the photoresist 20 into a methanol solution, and the photoresist 20 can be removed, as shown in FIG. 2F.

In step S24: the vertical-type optical waveguide 100 is formed by coating titanium (Ti) film 30 on the protrusion portion 14 and diffusing the Ti into the protrusion portion 14 by a high temperature diffusion technology, as shown in FIG. 2G. Diffusion temperature is 1020°.

Above mentioned manufacturing process the first and second grooves of the vertical-type optical waveguide have maximum alignment and flatness. This method also omits a photolithography process for forming the grooves, increasing optical effectiveness, and reduces manufacturing cost.

Although the present disclosure has been specifically described on the basis of these exemplary embodiments, the disclosure is not to be construed as being limited thereto. Various changes or modifications may be made to the embodiments without departing from the scope and spirit of the disclosure.

What is claimed is:

1. A vertical-type optical waveguide, comprising:
a substrate;
a first groove;
a second groove; and
a protrusion portion comprising titanium (Ti);
wherein the first groove and the second groove are defined on a top surface of the substrate and are perpendicular to the top surface; the first groove and the second groove extend parallel to each other; the protrusion portion is defined between the first groove and the second groove.

2. The vertical-type optical waveguide as claimed in claim 1, wherein the substrate is made of lithium niobate (LiNbO3) crystal.

3. The vertical-type optical waveguide as claimed in claim 1, wherein a Ti film is coated on the protrusion portion and then the protrusion portion is diffused with Ti.

4. The vertical-type optical waveguide as claimed in claim 1, wherein a depth from the top surface of the substrate to a bottom of the first groove is same as a depth from the top surface of the substrate to a bottom of the second groove.

5. The vertical-type optical waveguide as claimed in claim 1, wherein a distance between the first groove and the second groove is set according to different wavelengths of light.

6. The vertical-type optical waveguide as claimed in claim 5, wherein a distance between the first groove and the second groove is 9 μm.

7. A manufacturing process of a vertical-type optical waveguide, comprising steps:
S10: providing a substrate;
S12: slicing a first groove and a second groove into a top surface of the substrate, the first and the second grooves are perpendicular to the top surface, and forming a protrusion portion between the first groove and the second groove;
S16: spin coating a photoresist on the top surface of the substrate;
S18: removing the photoresist on a top of the protrusion portion;
S20: coating a titanium (Ti) film on the top surface of the protrusion portion;
S22: removing residual photoresist; and
S24: coating titanium (Ti) film on the protrusion portion and diffusing the Ti into the protrusion portion by a high temperature diffusion technology.

8. The manufacturing process of the vertical-type optical waveguide as claimed in claim 7, wherein a cutting machine employing a precision slicing wheel is used for the slicing process.

9. The manufacturing process of the vertical-type optical waveguide as claimed in claim 7, wherein the substrate is cleaned after the slicing process.

10. The manufacturing process of the vertical-type optical waveguide as claimed in claim 7, wherein a speed of the spin coating is not less than 6000 rpm.

11. The manufacturing process of the vertical-type optical waveguide as claimed in claim 7, wherein removing the photoresist uses photolithography technology.

12. The manufacturing process of the vertical-type optical waveguide as claimed in claim 7, wherein the photoresist is made of polymethyl methacrylate (PMMA), and a methanol solution is used for removing the photoresist.
